(19) United States
(12) Patent Application Publication
(10) Pub. No.: US 2026/0320094 A1
(43) Pub. Date: Oct. 15, 2026

(54) EFFICIENT UTILIZATION OF GENERATIVE ARTIFICIAL INTELLIGENCE

(71) Applicant: Google LLC, Mountain View, CA (US)

(72) Inventors: Xiaohang Li, Cupertino, CA (US); Feng Yang, Sunnyvale, CA (US)

(21) Appl. No.: 18/861,275

(22) PCT Filed: Nov. 30, 2023
(86) PCT No.: PCT/US2023/081801

§ 371 Date: Oct. 29, 2024

(51) Int. Cl. G06F 16/334; G06F 16/3332

(52) U.S. Cl. CPC G06F 16/334; G06F 16/3334

(57) ABSTRACT

Methods, systems, and apparatus, including computer programs encoded on a computer storage medium, for efficiently providing digital components that are generated using artificial intelligence based on prompts are described. In one aspect, a method includes maintaining, by an AI system, a data structure that stores a set of pre-generated digital components and, for each pre-generated digital component, a stored embedding the represents a prompt used to generate the pre-generated digital component. The AI system receives, from a device, a first input prompt for generating one or more first target digital components using one or more trained machine learning models. The AI system generates a first input embedding that represents the multi-word text of the input prompt. The AI system determines, for each pre-generated digital component, a similarity metric that represents a measure of similarity between the stored embedding used to generate the digital component and the first input embedding.

### BACKGROUND

This specification relates to data processing, artificial intelligence, and generating content using artificial intelligence.

Advances in machine learning are enabling artificial intelligence to be implemented in more applications. For example, diffusion models have been implemented to generate images based on prompts provided to the models.

### SUMMARY

In general, one innovative aspect of the subject matter described in this specification can be embodied in methods that include the actions of maintaining, by an artificial intelligence system, a data structure that stores a set of pre-generated digital components and, for each pre-generated digital component, a stored embedding the represents a prompt used to generate the pre-generated digital component; receiving, by the artificial intelligence system from a device, a first input prompt for generating one or more first target digital components using one or more trained machine learning models, the first input prompt comprising a multi-word phrase describing characteristics of the first target digital component to be generated using the first input prompt; generating, by the artificial intelligence system, a first input embedding that represents the multi-word text of the input prompt; determining, by the artificial intelligence system and for each pre-generated digital component, a similarity metric that represents a measure of similarity between the stored embedding used to generate the pre-generated digital component and the first input embedding; and sending, by the artificial intelligence system and to the device based on each similarity metric, either one or more of the pre-generated digital components stored in the data structure or one or more new digital components pre-generated by the trained machine learning model using the first input prompt. Other implementations of this aspect include corresponding apparatus, systems, and computer programs, configured to perform the aspects of the methods, encoded on computer storage devices.

These and other embodiments can each optionally include one or more of the following features. In some aspects, sending either one or more of the pre-generated digital components stored in the data structure or one or more new digital components generated by the trained machine learning model using the first input prompt includes determining that the similarity metric for the one or more pre-generated digital components satisfies a similarity threshold and sending the one or more pre-generated digital components to the device in response to determining that the similarity metric for the one or more pre-generated digital components satisfies a similarity threshold.

In some aspects, sending either one or more of the pre-generated digital components stored in the data structure or one or more new digital components generated by the trained machine learning model using the first input prompt includes determining that the similarity metric for each of a plurality of the pre-generated digital components satisfies a similarity threshold and, in response to determining that the similarity metric for each of the plurality of the pre-generated digital components satisfies the similarity threshold, selecting, from among the plurality of pre-generated digital components, the one or more pre-generated digital components based on the similarity metric for each of the plurality of pre-generated digital components and sending the one or more pre-generated digital components to the device.

In some aspects, sending either one or more of the pre-generated digital components stored in the data structure or one or more new digital components generated by the trained machine learning model using the first input prompt includes determining that the similarity metric for each pre-generated digital components stored in the data structure fails to satisfy a similarity threshold and, in response to determining that the similarity metric for each pre-generated digital component stored in the data structure fails to satisfy the similarity threshold, generating the one or more new digital components by providing the first input prompt to the one or more trained machine learning models and sending the one or more new digital components to the device. Some aspects include adding the one or more new digital components and the first input prompt to the data structure for distribution to devices in response to new input prompts being classified as similar to the first input prompt.

In some aspects, sending either one or more of the pre-generated digital components stored in the data structure or one or more new digital components generated by the trained machine learning model using the first input prompt includes determining that the similarity metric for the one or more pre-generated digital components satisfies a similarity threshold and, in response to determining that the similarity metric for the one or more pre-generated digital components satisfies the similarity threshold, determining, based on a function, whether to send the one or more pre-generated digital components or to generate the one or more new digital components using customization information for a sender of the first input prompt; whenever a determination is made to send the one or more pre-generated digital components, sending the one or more pre-generated digital components to the device; and whenever a determination is made to generate the one or more new digital components using customization information for a sender of the first input prompt, generating an updated prompt based on the first input prompt and the customization information for the sender of the first input prompt, generating the one or more new digital components by providing the updated prompt to the one or more trained machine learning models, and sending the one or more new digital components to the device.

In some aspects, the data structure includes a cache of the artificial intelligence system. Some aspects include periodically updating the cache. The updating can include determining, for each pre-generated digital component stored in the data structure, a duration of time since a last input prompt for which the similarity metric for the stored embedding used to generate the pre-generated digital component satisfies a similarity threshold was received and removing each pre-generated digital component for which the duration of time exceeds a duration threshold.

Some aspects include pre-populating the data structure with one or more digital components generated using human-created prompts that were not previously received from devices of senders.

Some aspects include pre-populating the data structure with one or more digital components generated using prompts generated by a language model.

Some aspects include generating, for a digital component provider, a new prompt based on information obtained from one or more resources of the content provider; generating one or more new digital components using the new prompt; and sending, as recommended digital components, the one or more new digital components to the content provider.

Particular embodiments of the subject matter described in this specification can be implemented so as to realize one or more of the following advantages. The techniques described in this document more efficiently utilize generative artificial intelligence (AI) models and associated computing infrastructure to generate new digital components by selectively bypassing or using the models based on prompt similarity metrics and/or an availability of pre-generated digital components. As running a generative AI model is computationally expensive and can be time consuming especially when many requests are received in a short time period, the techniques described in this document can reduce the usage of a generative AI model by bypassing the use of the model when suitable content has already been generated by the model. In such cases, the system can return the previously generated content in response to an input prompt rather than use the generative AI model to recreate digital components based on the input prompt.

In some implementations, the system stores content generated by generative AI models and embeddings that represent the prompts used to generate the content in a data structure, e.g., a cache or database, which can be in the form of a vector or string of numbers. An embedding is a dense numerical representation of an object, e.g., of a prompt for a generative AI model. When an input prompt is received, the system can generate an input embedding that represents the input prompt and evaluate the similarity between the input prompt and the stored prompts based on their respective embeddings. Using embeddings in this way enables the system to more quickly and more accurately evaluate the similarity between the input prompt and the stored prompts to determine whether there are stored digital components that are suitable for providing in response to the received input prompt, relative to systems that compare digital components for similarity or the text of the prompts for similarity. For example, the user of embeddings enables fast and efficient nearest neighbor searches for retrieving embeddings that are most similar to the input embedding rather that performing a semantic analysis between words of the prompts. This enables the system to more quickly return suitable digital components in response to receiving input prompts, especially when suitable stored digital components are identified as being similar using the embeddings.

The use of these digital component storage and embedding similarity techniques enables the system to provide digital components in real-time, e.g., in milliseconds, in response to requests for contents. For example, when there are no similar stored embeddings for an input prompt, the system can still respond quickly by providing default digital components depending on the sender of the prompt or a subject of the content of the digital component. The system can then use the generative AI model in an offline process to generate new digital components based on the input prompt. This enables the system to expand the data structure to include additional digital components and respond quickly if a similar prompt is received in the future, making it increasingly likely that a suitable digital component will be found without generating a new digital component.

Enhanced memory management techniques, e.g., cache management techniques, can be used to reduce the amount of digital components and corresponding embeddings are stored in the data structure, freeing up memory for other data, reducing the amount of memory devices required by the system, and/or enabling faster similarity checks when input prompts are received. For example, the system can remove digital components and corresponding embeddings if the system does not receive an input prompt that is similar to the digital components' prompts over a period of time, which indicates that the prompt may not be common or popular. By selectively storing only some prompts (e.g., popular prompts) or embeddings that represent the prompts along with their digital components, these memory management techniques also reduce the number of similarity calculations performed to identify prompts or embeddings that are similar to an input prompt or embedding without significantly reducing the number of cache hits, thereby reducing the amount of resources used to compute the similarity metrics and the associated latency.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which digital components are generated using artificial intelligence.

FIG. 2 is a block diagram illustrating interactions between an artificial intelligence system, a generative model, a data structure, and a device.

FIG. 3 is a flow chart of an example process of sending digital components in response to input prompts.

FIG. 4 is a flow chart of an example process of selecting or generating digital components to send to a device based on similarity metrics.

FIG. 5 a block diagram of an example computer.

Like reference numbers and designations in the various drawings indicate like elements.

### DETAILED DESCRIPTION

This specification describes techniques for efficiently providing digital components that are generated using artificial intelligence based on prompts. Artificial intelligence (AI) is a segment of computer science that focuses on the creation of models that can perform tasks autonomously (e.g., with little to no human intervention). Artificial intelligence systems can utilize, for example, one or more of machine learning, natural language processing, or computer vision. Machine learning, and its subsets, such as deep learning, focus on developing models that can infer outputs from data. The outputs can include, for example, predictions and/or classifications. Natural language processing focuses on analyzing and generating human language. Computer vision focuses on analyzing and interpreting images and videos. Artificial intelligence systems can include generative models that generate new content, such as images, videos, text, audio, and/or other content, in response to input prompts and/or based on other information.

The techniques described throughout this specification enable artificial intelligence to generate customized digital components based on input prompts received from devices, e.g., devices of digital component providers that provide digital components to users and/or client devices of users to which digital components are distributed. As used throughout this document, the phrase “digital component” refers to a discrete unit of digital content or digital information (e.g., a video clip, audio clip, multimedia clip, gaming content, image, text, bullet point, artificial intelligence output, language model output, or another unit of content). A digital component can electronically be stored in a physical memory device as a single file or in a collection of files, and digital components can take the form of video files, audio files, multimedia files, image files, or text files and include advertising information, such that an advertisement is a type of digital component.

To efficiently provide digital components in response to prompts, an AI system can maintain a data structure, e.g., cache or database, that maps data representing input prompts to pre-generated digital components that were previously generated using the prompts. As described in more detail below, the data representing a prompt can be an embedding, which enables fast and accurate similarity measurements between a new input prompt and prompts that were used to generate the pre-generated digital components. The pre-generated digital components can include digital components that were previously generated based on prompts received from devices. In some implementations, the data structure can also be populated with pre-generated digital components that are generated using prompts of a designer, administrator, or other human associated with the AI system, and/or prompts generated using a trained machine learning model, e.g., a language model.

When a new input prompt is received, the AI system can determine whether there are similar prompts stored in the data structure. If so, the AI system can provide one or more pre-generated digital components that were generated using the similar prompts. If not, the AI system can generate one or more new digital components by providing the prompt, or an updated prompt that is generated using the prompt and optionally additional customization information, to a generative model. The generative model can be, for example, a diffusion model, a text-to-image model (e.g., Muse or Parti), a text-to-video model (e.g., Imagen video), a text-to-code model, an image-to-image model, an image-to-video model, a language model, e.g., a large language model (LLM), or another type of generative model capable of generating images, video, text audio, and/or other content based on input prompts.

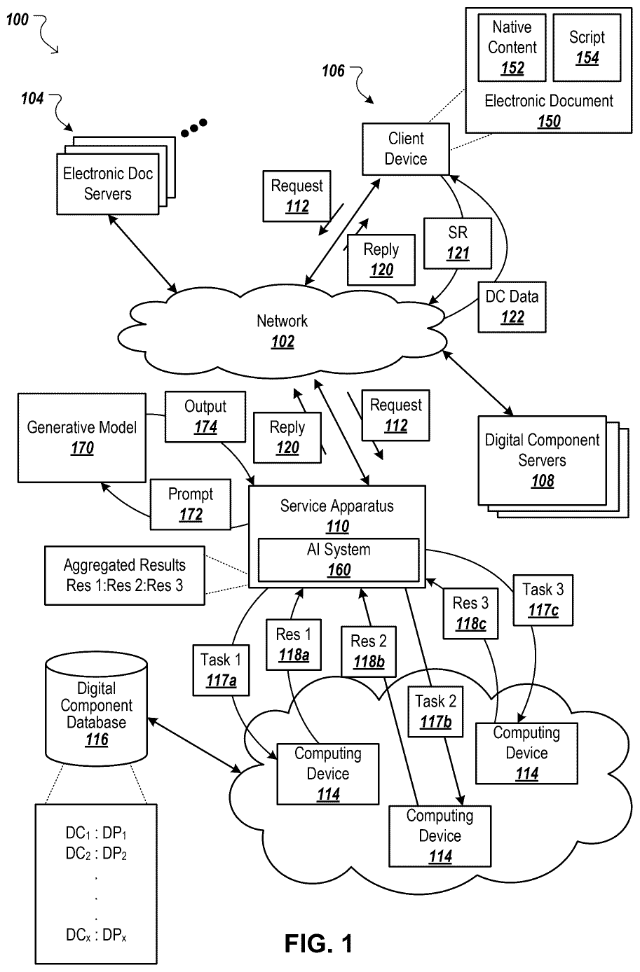

FIG. 1 is a block diagram of an example environment 100 in which digital components are generated using artificial intelligence. The example environment 100 includes a network 102, such as a local area network (LAN), a wide area network (WAN), the Internet, or a combination thereof. The network 102 connects electronic document servers 104, client devices 106, digital component servers 108, and a service apparatus 110. The example environment 100 may include many different electronic document servers 104, client devices 106, and digital component servers 108.

The service apparatus 110 is configured to provide various services to client devices 106, publishers of electronic documents 150, and/or to digital component providers. In some implementations, the service apparatus 110 generates digital components for users or digital component providers that distribute digital components to users. In some implementations, the service apparatus 110 distributes digital components to client devices 106 for presentation with electronic documents 150 and/or other types of resources. In this example, the service apparatus 110 can generate new digital components and distribute the digital components on behalf of digital components providers. For example, the service apparatus 110 can distribute digital components to client devices 110 in response context requests 112, as described below.

A client device 106 is an electronic device capable of requesting and receiving online resources over the network 102. Example client devices 106 include personal computers, gaming devices, mobile communication devices, digital assistant devices, augmented reality devices, virtual reality devices, and other devices that can send and receive data over the network 102. A client device 106 typically includes a user application, such as a web browser, to facilitate the sending and receiving of data over the network 102, but native applications (other than browsers) executed by the client device 106 can also facilitate the sending and receiving of data over the network 102.

A gaming device is a device that enables a user to engage in gaming applications, for example, in which the user has control over one or more characters, avatars, or other rendered content presented in the gaming application. A gaming device typically includes a computer processor, a memory device, and a controller interface (either physical or visually rendered) that enables user control over content rendered by the gaming application. The gaming device can store and execute the gaming application locally, or execute a gaming application that is at least partly stored and/or served by a cloud server (e.g., online gaming applications). Similarly, the gaming device can interface with a gaming server that executes the gaming application and “streams” the gaming application to the gaming device. The gaming device may be a tablet device, mobile telecommunications device, a computer, or another device that performs other functions beyond executing the gaming application.

Digital assistant devices include devices that include a microphone and a speaker. Digital assistant devices are generally capable of receiving input by way of voice, and respond with content using audible feedback, and can present other audible information. In some situations, digital assistant devices also include a visual display or are in communication with a visual display (e.g., by way of a wireless or wired connection). Feedback or other information can also be provided visually when a visual display is present. In some situations, digital assistant devices can also control other devices, such as lights, locks, cameras, climate control devices, alarm systems, and other devices that are registered with the digital assistant device.

As illustrated, the client device 106 is presenting an electronic document 150. An electronic document is data that presents a set of content at a client device 106. Examples of electronic documents include webpages, word processing documents, portable document format (PDF) documents, images, videos, search results pages, and feed sources. Native applications (e.g., “apps” and/or gaming applications), such as applications installed on mobile, tablet, or desktop computing devices are also examples of electronic documents. Electronic documents can be provided to client devices 106 by electronic document servers 104 (“Electronic Doc Servers”).

For example, the electronic document servers 104 can include servers that host publisher websites. In this example, the client device 106 can initiate a request for a given publisher webpage, and the electronic server 104 that hosts the given publisher webpage can respond to the request by sending machine executable instructions that initiate presentation of the given webpage at the client device 106.

In another example, the electronic document servers 104 can include app servers from which client devices 106 can download apps. In this example, the client device 106 can download files required to install an app at the client device 106, and then execute the downloaded app locally (i.e., on the client device). Alternatively, or additionally, the client device 106 can initiate a request to execute the app, which is transmitted to a cloud server. In response to receiving the request, the cloud server can execute the application and stream a user interface of the application to the client device 106 so that the client device 106 does not have to execute the app itself. Rather, the client device 106 can present the user interface generated by the cloud server's execution of the app, and communicate any user interactions with the user interface back to the cloud server for processing.

Electronic documents can include a variety of content. For example, an electronic document 150 can include native content 152 that is within the electronic document 150 itself and/or does not change over time. Electronic documents can also include dynamic content that may change over time or on a per-request basis. For example, a publisher of a given electronic document (e.g., electronic document 150) can maintain a data source that is used to populate portions of the electronic document. In this example, the given electronic document can include a script, such as the script 154, that causes the client device 106 to request content (e.g., a digital component) from the data source when the given electronic document is processed (e.g., rendered or executed) by a client device 106 (or a cloud server). The client device 106 (or cloud server) integrates the content (e.g., digital component) obtained from the data source into the given electronic document to create a composite electronic document including the content obtained from the data source.

In some situations, a given electronic document (e.g., electronic document 150) can include a digital component script (e.g., script 154) that references the service apparatus 110, or a particular service provided by the service apparatus 110. In these situations, the digital component script is executed by the client device 106 when the given electronic document is processed by the client device 106. Execution of the digital component script configures the client device 106 to generate a request for digital components (referred to as a “component request”), which is transmitted over the network 102 to the service apparatus 110. For example, the digital component script can enable the client device 106 to generate a packetized data request including a header and payload data. The component request 112 can include event data specifying features such as a name (or network location) of a server from which the digital component is being requested, a name (or network location) of the requesting device (e.g., the client device 106), and/or information that the service apparatus 110 can use to select one or more digital components, or other content, provided in response to the request. The component request 112 is transmitted, by the client device 106, over the network 102 (e.g., a telecommunications network) to a server of the service apparatus 110.

The component request 112 can include event data specifying other event features, such as the electronic document being requested and characteristics of locations of the electronic document at which digital component can be presented. For example, event data specifying a reference (e.g., URL) to an electronic document (e.g., webpage) in which the digital component will be presented, available locations of the electronic documents that are available to present digital components, sizes of the available locations, and/or media types that are eligible for presentation in the locations can be provided to the service apparatus 110. Similarly, event data specifying keywords associated with the electronic document (“document keywords”) or entities (e.g., people, places, or things) that are referenced by the electronic document can also be included in the component request 112 (e.g., as payload data) and provided to the service apparatus 110 to facilitate identification of digital components that are eligible for presentation with the electronic document.

The event data can also include a search query that was submitted from the client device 106 to obtain a search results page or a response in a conversational user interface. For example, an AI agent or other form of a chat agent can provide a conversational user interface in which users can provide natural language queries, which can be in the form of prompts for a language model, and receive responses to the queries. The user can refine their expression of their informational needs as the conversation progresses and the AI agent can send component requests 112 with the update queries.

Component requests 112 can also include event data related to other information, such as information that a user of the client device has provided, geographic information indicating a state or region from which the component request was submitted, or other information that provides context for the environment in which the digital component will be displayed (e.g., a time of day of the component request, a day of the week of the component request, a type of device at which the digital component will be displayed, such as a mobile device or tablet device). Component requests 112 can be transmitted, for example, over a packetized network, and the component requests 112 themselves can be formatted as packetized data having a header and payload data. The header can specify a destination of the packet and the payload data can include any of the information discussed above.

The service apparatus 110 chooses digital components (e.g., third-party content, such as video files, audio files, images, text, gaming content, augmented reality content, and combinations thereof, which can all take the form of advertising content or non-advertising content) that will be presented with the given electronic document (e.g., at a location specified by the script 154) in response to receiving the component request 112 and/or using information included in the component request 112.

In some implementations, a digital component is selected in less than a second to avoid errors that could be caused by delayed selection of the digital component. For example, delays in providing digital components in response to a component request 112 can result in page load errors at the client device 106 or cause portions of the electronic document to remain unpopulated even after other portions of the electronic document are presented at the client device 106.

Also, as the delay in providing the digital component to the client device 106 increases, it is more likely that the electronic document will no longer be presented at the client device 106 when the digital component is delivered to the client device 106, thereby negatively impacting a user's experience with the electronic document. Further, delays in providing the digital component can result in a failed delivery of the digital component, for example, if the electronic document is no longer presented at the client device 106 when the digital component is provided. The described techniques are adapted to generate a customized digital component in a short amount of time such that these errors and user experience impact are reduced or eliminated.

In some implementations, the service apparatus 110 is implemented in a distributed computing system that includes, for example, a server and a set of multiple computing devices 114 that are interconnected and identify and distribute digital component in response to requests 112. The set of multiple computing devices 114 operate together to identify a set of digital components that are eligible to be presented in the electronic document from among a corpus of millions of available digital components (DC₁₋ₓ). The millions of available digital components can be indexed, for example, in a digital component database 116. Each digital component index entry can reference the corresponding digital component and/or include distribution parameters (DP₁-DPₓ) that contribute to (e.g., trigger, condition, or limit) the distribution/transmission of the corresponding digital component. For example, the distribution parameters can contribute to (e.g., trigger) the transmission of a digital component by requiring that a component request include at least one criterion that matches (e.g., either exactly or with some pre-specified level of similarity) one of the distribution parameters of the digital component.

In some implementations, the distribution parameters for a particular digital component can include distribution keywords that must be matched (e.g., by electronic documents, document keywords, or terms specified in the component request 112) in order for the digital component to be eligible for presentation. Additionally, or alternatively, the distribution parameters can include embeddings that can use various different dimensions of data, such as website details and/or consumption details (e.g., page viewport, user scrolling speed, or other information about the consumption of data). The distribution parameters can also require that the component request 112 include information specifying a particular geographic region (e.g., country or state) and/or information specifying that the component request 112 originated at a particular type of client device (e.g., mobile device or tablet device) in order for the digital component to be eligible for presentation. The distribution parameters can also specify an eligibility value (e.g., ranking score, or some other specified value) that is used for evaluating the eligibility of the digital component for distribution/transmission (e.g., among other available digital components).

The identification of the eligible digital component can be segmented into multiple tasks 117a-117c that are then assigned among computing devices within the set of multiple computing devices 114. For example, different computing devices in the set 114 can each analyze a different portion of the digital component database 116 to identify various digital components having distribution parameters that match information included in the component request 112. In some implementations, each given computing device in the set 114 can analyze a different data dimension (or set of dimensions) and pass (e.g., transmit) results (Res 1-Res 3) 118a-118c of the analysis back to the service apparatus 110. For example, the results 118a-118c provided by each of the computing devices in the set 114 may identify a subset of digital components that are eligible for distribution in response to the component request and/or a subset of the digital component that have certain distribution parameters. The identification of the subset of digital components can include, for example, comparing the event data to the distribution parameters, and identifying the subset of digital components having distribution parameters that match at least some features of the event data.

The service apparatus 110 aggregates the results 118a-118c received from the set of multiple computing devices 114 and uses information associated with the aggregated results to select one or more digital components that will be provided in response to the request 112. For example, the service apparatus 110 can select a set of winning digital components (one or more digital components) based on the outcome of one or more content evaluation processes, as discussed below. In turn, the service apparatus 110 can generate and transmit, over the network 102, reply data 120 (e.g., digital data representing a reply) that enable the client device 106 to integrate the set of winning digital components into the given electronic document, such that the set of winning digital components (e.g., winning third-party content) and the content of the electronic document are presented together at a display of the client device 106. In some implementations, the client device 106 executes instructions included in the reply data 120, which configures and enables the client device 106 to obtain the set of winning digital components from one or more digital component servers 108. For example, the instructions in the reply data 120 can include a network location (e.g., a Uniform Resource Locator (URL)) and a script that causes the client device 106 to transmit a server request (SR) 121 to the digital component server 108 to obtain a given winning digital component from the digital component server 108. In response to the request, the digital component server 108 will identify the given winning digital component specified in the server request 121 (e.g., within a database storing multiple digital components) and transmit, to the client device 106, digital component data (DC Data) 122 that presents the given winning digital component in the electronic document at the client device 106.

When the client device 106 receives the digital component data 122, the client device will render the digital component (e.g., third-party content), and present the digital component at a location specified by, or assigned to, the script 154. For example, the script 154 can create a walled garden environment, such as a frame, that is presented within, e.g., beside, the native content 152 of the electronic document 150. In some implementations, the digital component is overlayed over (or adjacent to) a portion of the native content 152 of the electronic document 150, and the service apparatus 110 can specify the presentation location within the electronic document 150 in the reply 120. For example, when the native content 152 includes video content, the service apparatus 110 can specify a location or object within the scene depicted in the video content over which the digital component is to be presented.

The service apparatus 110 can also include an artificial intelligence (AI) system 160 configured to autonomously generate digital components, either prior to a request 112 (e.g., offline) and/or in response to a request 112 (e.g., online or real-time). As described in more detail herein, the AI system 160 can collect online content about a specific entity (e.g., digital component provider or another entity) and use the information to generate digital components.

The AI system 160 can generate digital components using a generative model 170. The generative model 170 can be implemented as an AI model that is trained to generate images, video, text, and/or audio based on prompts 172 provided as input to the generative model 170. For example, the generative model 170 can be a diffusion model, a text-to-image model, a language model (e.g., an LLM), or another type of generative model capable of generating images, video, text audio, and/or other content based on input prompts.

A large language model (“LLM”) is a model that is trained to generate and understand human language. LLMs are trained on massive datasets of text and code, and they can be used for a variety of tasks. For example, LLMs can be trained to translate text from one language to another; summarize text, such as web site content, search results, news articles, or research papers; answer questions about text, such as “What is the capital of Georgia?”; create chatbots that can have conversations with humans; and generate creative text, such as poems, stories, and code.

The language model can be any appropriate language model neural network that receives an input sequence made up of text tokens selected from a vocabulary and auto-regressively generates an output sequence made up of text tokens from the vocabulary. For example, the language model can be a Transformer-based language model neural network or a recurrent neural network-based language model.

In some situations, the language model can be referred to as an auto-regressive neural network when the neural network used to implement the language model auto-regressively generates an output sequence of tokens. More specifically, the auto-regressively generated output is created by generating each particular token in the output sequence conditioned on a current input sequence that includes any tokens that precede the particular text token in the output sequence, i.e., the tokens that have already been generated for any previous positions in the output sequence that precede the particular position of the particular token, and a context input that provides context for the output sequence.

For example, the current input sequence when generating a token at any given position in the output sequence can include the input sequence and the tokens at any preceding positions that precede the given position in the output sequence. As a particular example, the current input sequence can include the input sequence followed by the tokens at any preceding positions that precede the given position in the output sequence. Optionally, the input and the current output sequence can be separated by one or more predetermined tokens within the current input sequence.

More specifically, to generate a particular token at a particular position within an output sequence, the neural network of the language model can process the current input sequence to generate a score distribution, e.g., a probability distribution, that assigns a respective score, e.g., a respective probability, to each token in the vocabulary of tokens. The neural network of the language model can then select, as the particular token, a token from the vocabulary using the score distribution. For example, the neural network of the language model 170 can greedily select the highest-scoring token or can sample, e.g., using nucleus sampling or another sampling technique, a token from the distribution.

As a particular example, the language model can be an auto-regressive Transformer-based neural network that includes (i) a plurality of attention blocks that each apply a self-attention operation and (ii) an output subnetwork that processes an output of the last attention block to generate the score distribution.

The language model can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv:2203.15556, 2022; J. W. Rae, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d'Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv:1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al. Language models are few-shot learners. arXiv preprint arXiv:2005.14165, 2020.

Generally, however, the Transformer-based neural network includes a sequence of attention blocks, and, during the processing of a given input sequence, each attention block in the sequence receives a respective input hidden state for each input token in the given input sequence. The attention block then updates each of the hidden states at least in part by applying self-attention to generate a respective output hidden state for each of the input tokens. The input hidden states for the first attention block are embeddings of the input tokens in the input sequence and the input hidden states for each subsequent attention block are the output hidden states generated by the preceding attention block.

In this example, the output subnetwork processes the output hidden state generated by the last attention block in the sequence for the last input token in the input sequence to generate the score distribution.

Generally, because the language model is auto-regressive, the service apparatus 110 can use the same language model to generate multiple different candidate output sequences in response to the same request, e.g., by using beam search decoding from score distributions generated by the language model, using a Sample-and-Rank decoding strategy, by using different random seeds for the pseudo-random number generator that's used in sampling for different runs through the language model or using another decoding strategy that leverages the auto-regressive nature of the language model.

In some implementations, the language model is pre-trained, e.g., trained on a language modeling task that does not require providing evidence in response to user questions, and the service apparatus 110 (e.g., using AI system 160) causes the language model to generate output sequences according to the pre-determined syntax through natural language prompts in the input sequence.

For example, the service apparatus 110 (e.g., AI system 160), or a separate training system, pre-trains the language model (e.g., the neural network) on a language modeling task, e.g., a task that requires predicting, given a current sequence of text tokens, the next token that follows the current sequence in the training data. As a particular example, the language model 170 can be pre-trained on a maximum-likelihood objective on a large dataset of text, e.g., text that is publicly available from the Internet or another text corpus.

In some implementations, the AI system 160 can generate a prompt 172 that is submitted to the generative model 170, and causes the generative model 170 to generate output sequences 174, also referred to simply as “output”. The AI system 160 can generate the prompt in a manner (e.g., having a structure) that instructs the generative model 170 to generate the output.

In some implementations, the AI system 160 can generate the prompt 172 based on received, collected, and/or generated data, and the output 174 of the generative model 170 can be a digital component. For example, the AI system 160 can generate the prompt 172 based on an input prompt received from a device, e.g., a client device 106 of a user or a device of a digital component provider. The prompt 172 can include the input prompt and optionally additional data, e.g., customization information for a digital component provider.

An input prompt can be received from a client device 106 as part of a component request 112. For example, a script 154 can be configured to generate an input prompt based on event data described above. In another example, the AI system 160 can be configured to generate the prompt 172 based on the data of a component request 112, e.g., such that the script 154 does not have to include a prompt. In particular, the AI system 160 can be configured to generate a prompt 172 by populating a prompt template with data of the component request 112 or by providing the data to a language model with instructions to generate a prompt 172 for generating text or an image for a digital component.

A digital component provider can generate an input prompt in any manner to convey the target digital component to be generated by the AI system. For example, a digital component provider can generate a natural language prompt that describes the target content to be depicted by the digital component.

The customization information for a digital component provider can include information about the digital component provider and/or information about digital components provided by the digital component provider. For example, the AI system 160 can obtain the customization information for a digital component provider from electronic documents (e.g., landing pages) of the digital component provider, e.g., by crawling the electronic documents to identify text and/or images depicted by the electronic documents, the structure of the electronic documents, and/or characteristics that are specified in the structure of the electronic documents. For example, an HTML structure of a web page can be examined to determine color information in different portions of the web page, textures or patterns that occupy different portions of the web page, fonts used, and/or other formatting settings for the web page. The AI system 160 can evaluate the text and/or images to identify keywords, item names, characteristics of the items, topics, contextual information, promotions, and/or other information that can be used to generate digital components. A digital component provider can also provide the customization information for use in generating digital components for the digital component provider.

The AI system 160 can generate new digital components by providing prompts 172 to the generative model 170. The generative model 170 can be trained to generate digital components and provide the generated digital components as outputs 174 of the generative model. For example, a language model can be trained as described above. Each prompt 172 can be a multi-word phrase that instructs the generative model 170 to generate a digital component.

As described in more detail below, the AI system 160 can determine whether to return one or more pre-generated digital components or to generate one or more new digital components based on a prompt 172, e.g., an input prompt received from a device or a prompt generated based on an input prompt or other data received from a device. For example, if the prompt 172 is similar to a previous prompt 172 that was used to generate digital components that are stored by the AI system 160, the AI system 160 can provide one or more of the stored digital components rather than generate new digital components using the generative model 170 since the generative model 170 can be computationally expensive and time consuming. If there are no similar prompts, the AI system 160 can generate one or more new digital components by providing the prompt 172 to the generative model.

Bypassing the generative model 170 when similar prompts are identified can be particularly advantageous for situations in which the AI system 160 is providing digital components in response to a content request 112 and the digital components have to be provided within milliseconds of receiving the component request 112. For example, it may take some generative models seconds or even minutes to generate a new image or video such that the generative models cannot be used in real-time to generate new digital components in response to content requests 112. Using these techniques, digital components generated using AI can still be provided in response to content requests 112 when the prompt 172 is sufficiently similar (e.g., within a threshold as described below) without introducing the latency and computational burden involved with generating new digital components for every component request 112.

Although a single generative model 170 is shown in FIG. 1, different generative models can be specially trained to process different prompts. For example, the AI system 160 can include different generative models for different types of digital components, e.g., some for text, some for images, some for videos, etc. In another example, the AI system 160 can include different generative models for different types or categories of items that are the subject of the digital components. For example, the AI system 160 can include a first generative model for gardening equipment and a second generative model for men's clothing.

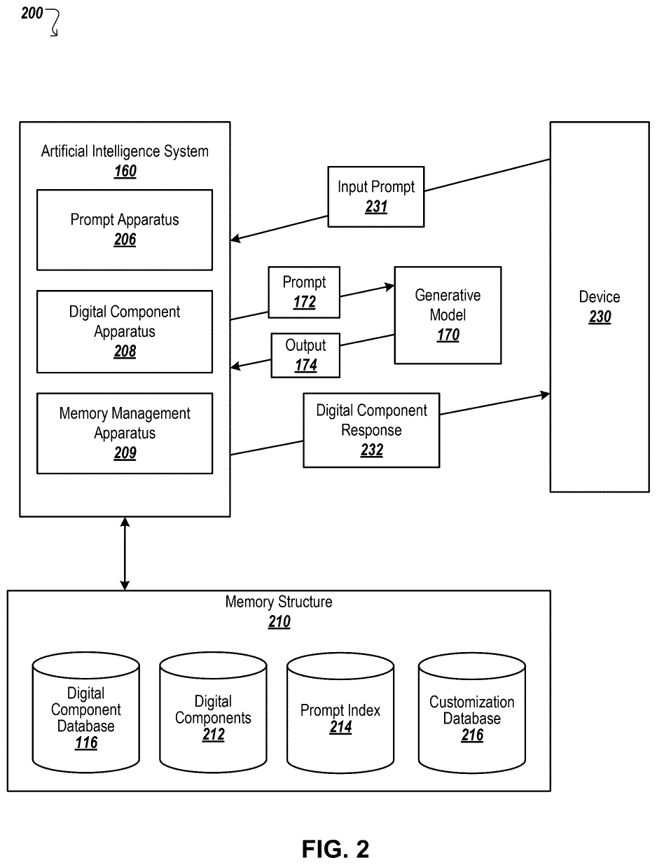

FIG. 2 is a block diagram illustrating interactions between an AI system 160, a generative model 170, a data structure 214, and a device 230. In this example, the AI system 160 includes a prompt apparatus 206, a digital component apparatus 208, and a memory management apparatus 209. The AI system 160 can also include or be configured to interact with a memory structure 210 to extract and/or store information and content. In particular, the memory structure 210 can store the digital component database 116, digital components 212, a prompt index 214, and a customization database 216. The memory structure 210 can include one or more databases or other data structures stored on one or more memories and/or data storage devices. In some implementations, the digital components 212 and the prompt index 214 are stored in a cache that is part of the memory structure 210 or another part of memory of the AI system 160.

The digital components 212 can include pre-generated digital components that have been generated by the AI system 160, e.g., using a generative model 170. The digital components 212 can include digital components that were generated in response to input prompts received from devices 230, e.g., client devices 106 of users and/or devices of digital component providers. For example, each time the AI system 160 generates a new digital component based on a prompt 172, the AI system 160 can store the new digital component in the memory structure 210.

The AI system 160 can also generate digital components using prompts 172 generated by a designer, administrator, or other human associated with the AI system 160. For example, the memory structure 210 can be pre-populated with digital components prior to receiving input prompts from devices. In another example, the AI system 160 can generate digital components using prompts 172 generated using a trained machine learning model, e.g., a language model. For example, the AI system 160 can provide customization information for each of multiple digital component providers and request a prompt 172 for each digital component provider. The AI system 160 can then provide each prompt 172 to the generative model to create new digital components for storage in the memory structure 210. Digital components stored in the memory structure 210 can also be referred to as pre-generated digital components or stored digital components.

The prompt index 214 can map prompts 172 to pre-generated digital components that were generated by a generative model 170 using the prompts 172. In some implementations, the prompt index 214 can include, for each prompt 172, an embedding that represents the prompt 172 and a reference to (e.g., a unique identifier for) each of one or more digital components generated using the prompt 172. The AI system 160 can generate, for each prompt 172, an embedding that represents the prompt 172. The embedding can be generated using a machine learning model, e.g., neural network, that is trained to generate embeddings that represent multi-word prompts 172. For example, this embedding generation model can be an image-text encode-decoder foundation model (e.g., CoCa) or a multi-modal vision and language model (e.g., CLIP). These example embedding generation models are multimodal and capable of producing image embeddings, text embeddings, and image-text embeddings, e.g., using contrastive learning. Each embedding can be a vector or string of numbers, e.g., floating-point numbers, that represents the prompt 172. For example, an embedding can include 32, 64, or another number of floating-point numbers arranged in a vector or string.

The customization database 216 stores customization information for digital component providers. The customization database 216 can store customization information for digital component providers that have selected to have their digital components customized using the customization information, in addition to the input prompts provided by the digital component provider. As described in more detail below, the AI system 160 can use a function to determine when to use the customization information for such digital component providers. As described above, the customization information for a digital component provider can include information about the digital component provider and/or information about digital components provided by the digital component provider.

The AI system 160 can receive input prompts 231 from devices 230 and provide digital component responses 232 that include one or more digital components to the devices 230 based on the input prompts 231. When an input prompt 231 is received, the prompt apparatus 206 can determine whether the prompt index 214 includes a prompt that is similar to the input prompt 231 or a prompt 172 generated based on the input prompt 231. In some cases, the input prompt 231 may not be in the form of a prompt for a generative model 170 and the AI system 160 can generate a prompt 172 using the input, as described above. The prompt apparatus 210 can access the memory structure 210 to obtain the prompts or embeddings that are indexed in the prompt index 214.

To determine whether the prompt index 214 includes a similar prompt, the prompt apparatus 206 can compare the input prompt 231 (or prompt 172 generated using the input prompt 231) to each prompt stored in the prompt index 214. The prompt apparatus 206 can determine, based on the comparison between the input prompt 231 (or prompt 172 generated using the input prompt 231) and the stored prompt, a similarity metric that represents the similarity between the input prompt 231 (or prompt 172 generated using the input prompt 231) and the stored prompt.

To more accurately and more quickly assess the similarity, the prompt apparatus 206 can generate an embedding that represents the input prompt 231 (or prompt 172 generated using the input prompt 231) and evaluate the similarity between this embedding and the stored embedding for each prompt indexed in the prompt index 214. The prompt apparatus 206 can determine, for each stored embedding, a similarity metric that represents the similarity between the stored embedding and the input prompt 231 (or prompt 172 generated using the input prompt 231). For example, the prompt apparatus 206 can determine, as the similarity metric, the cosine similarity between the stored embedding and the input prompt 231 (or prompt 172 generated using the input prompt 231). The prompt apparatus 206 can use the same model to generate both the stored embeddings and the embedding of the input prompt so that the similarity metrics are based on embeddings generated using the same model.

The prompt apparatus 206 can provide the similarity metrics to the digital component apparatus 208. The digital component apparatus 208 can determine, based on the similarity metrics, whether to provide one or more pre-generated digital components 212 or to generate one or more new digital components and provide the one or more new digital components.

For example, the digital component apparatus 208 can compare the similarity metrics to a similarity threshold. If any of the similarity metrics satisfies the similarity threshold, e.g., by meeting or exceeding the similarity threshold, the digital component apparatus 208 can determine to provide one or more pre-generated digital components 232 as part of the digital component response 232.

In some cases, the AI system 160 can be configured to provide, as the digital component response 232, a predetermined number of digital components in response to an input prompt 231. In another example, the input prompt 231 can be part of a request for a predetermined number of digital components. In either case, the digital component apparatus 208 can select from the pre-generated digital components 212 having a similarity metric that satisfies the similarity threshold up to the predetermined number. For example, the digital component apparatus 208 can select the pre-generated digital components having the highest similarity metrics.

If none of the similarity metrics satisfy the similarity threshold, the digital component apparatus 208 can generate one or more new digital components using the input prompt 231. For example, the digital component apparatus 208 can provide the input prompt 231 as a prompt 172 (or generate the prompt 172 using the input prompt 231) to one or more generative models 160. In a particular example, the digital component apparatus 208 can provide the prompt 172 to each generative model 170 appropriate for the prompt 172, e.g., the generative model(s) 170 for the type or category of item that is the subject of the digital component, the generative model(s) 170 specified by a request that includes the input prompt 231, and/or other generative models 170. The digital component apparatus 208 can receive the digital components as outputs 174 of the generative model(s) 170 and provide at least one of the digital components to the device 230 as part of the digital component response 232.

In some implementations, the digital component apparatus 208 can determine whether to use customization information to generate new digital components even when there are similar stored prompts indexed in the prompt index 214. For example, some digital component providers may specify that they want newly generated digital components for all of their input prompts. In this example, the digital component apparatus 208 can use the model(s) 170 to generate new digital components even if there are stored digital components that have prompts that are similar to the input prompt.

In another example, the digital component apparatus 208 can use a function to determine whether to use customization information to generate new digital components even when there are similar stored prompts indexed in the prompt index 214. This function can be based on whether the digital component provider has opted in to the use of customization information. For example, if the digital component provider has opted in, then the digital component apparatus 208 can determine to use the customization information to generate new digital components. In another example, the digital component provider can provide a function that specifies that all digital components generated for that digital component provider must be newly generated based on the input prompt e.g., even if there are similar stored prompts for which digital components have been generated and stored. In yet another example, a digital component provider can provide a prompt that specifies that a model is to be used to generate a digital component unless the similarity of a stored prompt satisfies (e.g., meets or exceeds a threshold).

For any newly generated digital components, the digital component apparatus 208 can store the digital component in the memory structure 210. The prompt apparatus 206 can also update the prompt index 214 to include the input prompt 231 (or prompt 172 generated using the input prompt 231) and/or embedding of the prompt, with a reference to the new digital component. In this way, the AI system 160 can generate a robust set of pre-generated digital components that can be sent to devices 230 in response to input prompts 231. For example, if a subsequent input prompt 231 that matches or is similar to this newly stored prompt 172 is received, the AI system 160 can return the now pre-generated digital components that were generated using the prompt 172.

The memory management apparatus 209 is configured to manage the data stored in the memory structure 209. For example, the memory management apparatus 209 can be configured to manage the amount of pre-generated digital components 212 stored in the memory structure 210, along with the corresponding prompts and/or embeddings in the prompt index 214. The memory management apparatus 209 can remove pre-generated digital components 214 that are not likely to be returned in response to input prompts 231 received from devices 230.

In some implementations, the memory management apparatus 209 can remove pre-generated digital components 212 and corresponding index data (e.g., data indexed in the prompt index 214) based on an amount of time since the AI system 160 received an input prompt 231 that (or for which a prompt 172 generated using the input prompt 231) matched was determined to be similar to the prompt used to generate the pre-generated digital component 212. For example, the memory management apparatus 209 can use a duration threshold to remove pre-generated digital components that have not been found to be similar to an input prompt 231.

In a particular example, the prompt apparatus 206 can maintain, in the prompt index 214 and for each pre-generated digital component, a last time at which an input prompt 231 (prompt 172 generated using the input prompt 231) was determined to match or be similar to the prompt 172 used to generate the pre-generated digital component such that the pre-generated digital component was eligible to be returned in response to the input prompt 231. If the duration of time between a current time (e.g., a time at which the memory management apparatus 209 is evaluating pre-generated digital components for removal) and the time stored in the prompt index satisfies the duration threshold, e.g., by meeting or exceeding the duration threshold, the memory apparatus 209 can remove the pre-generated digital component 212 and corresponding indexed data from the memory structure 210.

In another example, the memory management apparatus 209 can remove pre-generated digital components based on a number of times the pre-generated digital components have been sent to devices 230 in response to input prompts 231, e.g., over a time period. For example, the prompt apparatus 206 can maintain in the prompt index 214 a count of the number of times each pre-generated digital component has been provided in response to an input prompt 231 over the time period, The memory management apparatus 209 can compare the count for each pre-generated digital component to a count threshold and remove each pre-generated digital component and corresponding indexed data for which the count does not satisfy (e.g., does not meet or exceed) the count threshold. Using one or more of the memory management techniques performed by the memory management apparatus 209, input prompts 231 that may have been popular or common at one point in time but are no longer popular can be removed to free up memory space for newer and/or more common/popular input prompts 231.

In some implementations, the AI system 160 can be configured to provide recommended digital components to the devices 230 of digital component providers, e.g., without receiving an input prompt 231 to generate the recommended digital components from the devices 230. For example, the AI system 160 can pre-generate recommended digital components for a digital component provider based on the customization information for the digital component provider and one or more prompts. These prompts can include input prompts 231 received from other digital component providers or users or prompts generated by a designer, administrator, or other human associated with the AI system 160 or by a machine learning model, e.g., a language model. The AI system 160 can also store these pre-generated digital components in the memory structure 210 with their prompts and/or embeddings that represent the prompts. In this way, the AI system 160 can return a recommended pre-generated digital component to the digital component provider in response to an input prompt 231 from the digital component provider that matches or is similar to the prompt used to generate the recommended pre-generated digital component.

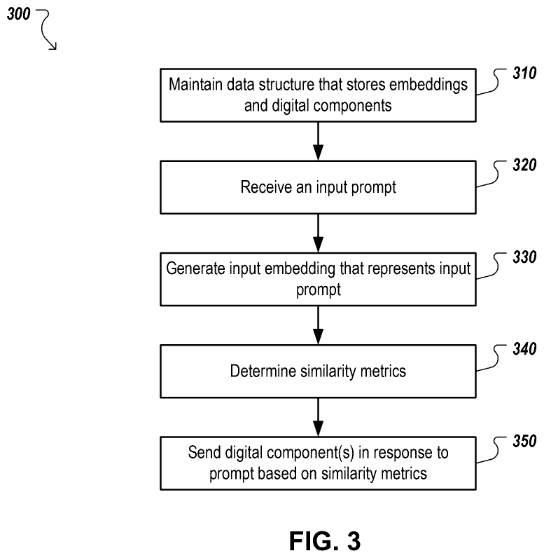

FIG. 3 is a flow chart of an example process 300 of sending digital components in response to input prompts. Operations of the process 300 can be performed, for example, by the service apparatus 110 of FIG. 1 (e.g., by the AI system 160), or another data processing apparatus. The operations of the process 300 can also be implemented as instructions stored on a computer readable medium, which can be non-transitory. Execution of the instructions, by one or more data processing apparatus, causes the one or more data processing apparatus to perform operations of the process 300. For brevity, the process 300 is described in terms of being performed by a system.

The system maintains a data structure that stores embeddings and digital components (310). The system can maintain a cache or database that stores pre-generated digital components and an index that maps the pre-generated digital components to the prompts used to generate the pre-generated digital components and/or to embeddings that represent the prompts. For each pre-generated digital component, the data structure (e.g., cache or database) can include a stored embedding that represents the prompt used to generate the pre-generated digital component. Optionally, the data structure can store the prompts for direct comparison with input prompts. The data structure can include the memory structure 210 of FIG. 2 or at least the pre-generated digital components 212 and the prompt index 214.

The system receives an input prompt (320). For example, the system can receive an input prompt from a device of a user or digital component provider. The input prompt can be a multi-word phrase that describes or otherwise characterizes a target digital component to be generated by the system. In some implementations, the system can generate the input prompt from data included in a request received from a device, e.g., using event data of a component request, as described above.

The system generates an input embedding that represents the input prompt (330). As described above, an embedding can be generated using a trained machine learning model. The embedding can include a vector or string of numbers that represents the multi-word phrase of the input prompt.

The system determines similarity metrics (340). The system can determine, for each stored embedding that is stored in the data structure, a similarity metric that represents a measure of similarity between the stored embedding used to generate a pre-generated digital component stored in the data structure and the input embedding. In some implementations, the system determines each similarity metric using cosine similarity between the two embeddings, a dot product between the two embeddings, or a Euclidean distance between the two embeddings. Other measures of similarity between vectors and/or strings of numbers can also be used. For example, the system can perform a nearest neighbors evaluation to identify the stored embeddings that are most similar to the input embedding.

The system sends one or more digital components to the device that provided the input prompt based on the similarity metrics (350). Depending on the similarity metrics, the system can either send one or more of the pre-generated digital components stored in the data structure or one or more new digital components pre-generated by the trained machine learning model using the first input prompt.

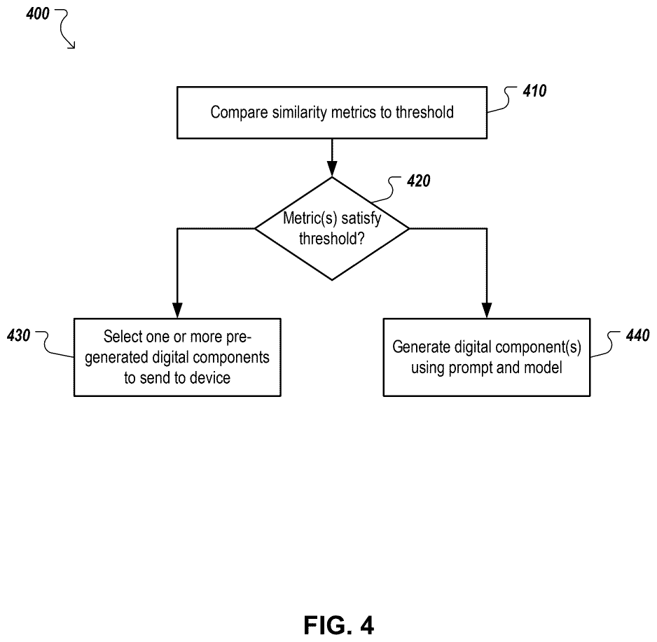

For example, if the similarity metric for at least one stored embedding satisfies a similarity threshold, the system can send, to the device, one or more pre-generated digital components for which the similarity metric for its stored embedding satisfies the similarity threshold. If none of the similarity metrics satisfy the threshold, the system can generate one or more new digital components using the input prompt and optionally customization information and send the one or more new digital components to the device. An example process for determining which digital components to provide based on similarity metrics is shown in FIG. 4.

FIG. 4 is a flow chart of an example process 400 of selecting or generating digital components to send to a device based on similarity metrics. Operations of the process 400 can be performed, for example, by the service apparatus 110 of FIG. 1 (e.g., by the AI system 160), or another data processing apparatus. The operations of the process 400 can also be implemented as instructions stored on a computer readable medium, which can be non-transitory. Execution of the instructions, by one or more data processing apparatus, causes the one or more data processing apparatus to perform operations of the process 400. For brevity, the process 400 is described in terms of being performed by a system.

The system compares similarity metrics to a similarity threshold (410). As described above with reference to operation 340 of FIG. 3, the system can determine a similarity metric for each stored embedding. The system can compare each similarity metric to a similarity threshold.

The system determines, for each similarity metric, whether the similarity metric satisfies a similarity threshold (420). For example, a similarity metric can satisfy the similarity threshold if the similarity metric meets (e.g., equals) or exceeds the similarity threshold.

If at least one similarity metric satisfies the similarity threshold, the system can select one or more pre-generated digital components to send to the device that provided the input prompt (430). For example, the system can send up to a specified number of pre-generated digital components for which the corresponding embedding has a similarity metric that satisfies the threshold. If there are more pre-generated digital components that are eligible based on the similarity metrics, the system can select the specified number from those eligible pre-generated digital components. For example, the system can select the pre-generated digital components for which their stored embeddings have the highest similarity metrics.

If none of the similarity metrics satisfy the similarity threshold, the system can generate one or more new digital components using the input prompt (440). The system can provide the input prompt as an input to one or more generative models to generate the one or more digital components. For example, the system can provide the input prompt to each generative model trained for a category or type of the item that is the subject of the digital components to be created.

In some implementations, the system can generate a prompt for each generative model based on an input prompt received from a device. For example, the system can adapt the input prompt to a suitable form for the generative model.

In some implementations, the system requires that more than one similarity metric satisfy the similarity threshold to select pre-generated digital components rather than generate new digital components. For example, a request that includes the input prompt may request a specified number of digital components. If there are less than the specified number of pre-generated digital components that have embeddings with similarity metrics that satisfy the similarity threshold, the system can determine to generate new digital components to fulfill the specified number of digital components.

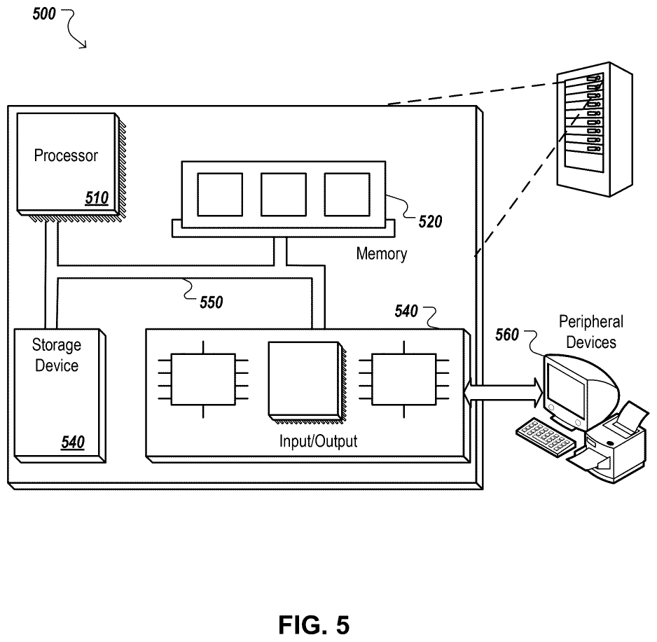

FIG. 5 is a block diagram of an example computer system 500 that can be used to perform operations described above. The system 500 includes a processor 510, a memory 520, a storage device 530, and an input/output device 540. Each of the components 510, 520, 530, and 540 can be interconnected, for example, using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 can include, for example, a hard disk device, an optical disk device, a storage device that is shared over a network by multiple computing devices (e.g., a cloud storage device), or some other large capacity storage device.

The input/output device 540 provides input/output operations for the system 500. In one implementation, the input/output device 540 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other devices, e.g., keyboard, printer, display, and other peripheral devices 560. Other implementations, however, can also be used, such as mobile computing devices, mobile communication devices, set-top box television client devices, etc.

Although an example processing system has been described in FIG. 5, implementations of the subject matter and the functional operations described in this specification can be implemented in other types of digital electronic circuitry, or in computer software, firmware, or hardware, including the structures disclosed in this specification and their structural equivalents, or in combinations of one or more of them.

An electronic document (which for brevity will simply be referred to as a document) does not necessarily correspond to a file. A document may be stored in a portion of a file that holds other documents, in a single file dedicated to the document in question, or in multiple coordinated files.

For situations in which the systems discussed here collect and/or use personal information about users, the users may be provided with an opportunity to enable/disable or control programs or features that may collect and/or use personal information (e.g., information about a user's social network, social actions or activities, a user's preferences, or a user's current location). In addition, certain data may be treated in one or more ways before it is stored or used, so that personally identifiable information associated with the user is removed. For example, a user's identity may be anonymized so that the no personally identifiable information can be determined for the user, or a user's geographic location may be generalized where location information is obtained (such as to a city, ZIP code, or state level), so that a particular location of a user cannot be determined.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

This document refers to a service apparatus. As used herein, a service apparatus is one or more data processing apparatus that perform operations to facilitate the distribution of content over a network. The service apparatus is depicted as a single block in block diagrams. However, while the service apparatus could be a single device or single set of devices, this disclosure contemplates that the service apparatus could also be a group of devices, or even multiple different systems that communicate in order to provide various content to client devices. For example, the service apparatus could encompass one or more of a search system, a video streaming service, an audio streaming service, an email service, a navigation service, an advertising service, a gaming service, or any other service.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method, comprising:
maintaining, by an artificial intelligence system, a data structure that stores a set of pre-generated digital components and, for each pre-generated digital component, a stored embedding the represents a prompt used to generate the pre-generated digital component;
receiving, by the artificial intelligence system from a device, a first input prompt for generating one or more first target digital components using one or more trained machine learning models, the first input prompt comprising a multi-word phrase describing characteristics of the first target digital component to be generated using the first input prompt;
generating, by the artificial intelligence system, a first input embedding that represents the multi-word text of the input prompt;
determining, by the artificial intelligence system and for each pre-generated digital component, a similarity metric that represents a measure of similarity between the stored embedding used to generate the pre-generated digital component and the first input embedding; and
sending, by the artificial intelligence system and to the device based on each similarity metric, either (i) one or more of the pre-generated digital components stored in the data structure or (ii) one or more new digital components pre-generated by the trained machine learning model using the first input prompt.

2. The method of claim 1, wherein sending either (i) one or more of the pre-generated digital components stored in the data structure or (ii) one or more new digital components generated by the trained machine learning model using the first input prompt comprises:
determining that the similarity metric for the one or more pre-generated digital components satisfies a similarity threshold; and
sending the one or more pre-generated digital components to the device in response to determining that the similarity metric for the one or more pre-generated digital components satisfies a similarity threshold.

3. The method of claim 1, wherein sending either (i) one or more of the pre-generated digital components stored in the data structure or (ii) one or more new digital components generated by the trained machine learning model using the first input prompt comprises:
determining that the similarity metric for each of a plurality of the pre-generated digital components satisfies a similarity threshold; and
in response to determining that the similarity metric for each of the plurality of the pre-generated digital components satisfies the similarity threshold:
selecting, from among the plurality of pre-generated digital components, the one or more pre-generated digital components based on the similarity metric for each of the plurality of pre-generated digital components; and
sending the one or more pre-generated digital components to the device.

4. The method of claim 1, wherein sending either (i) one or more of the pre-generated digital components stored in the data structure or (ii) one or more new digital components generated by the trained machine learning model using the first input prompt comprises:
determining that the similarity metric for each pre-generated digital components stored in the data structure fails to satisfy a similarity threshold; and
in response to determining that the similarity metric for each pre-generated digital component stored in the data structure fails to satisfy the similarity threshold:
generating the one or more new digital components by providing the first input prompt to the one or more trained machine learning models; and
sending the one or more new digital components to the device.

5. The method of claim 4, further comprising adding the one or more new digital components and the first input prompt to the data structure for distribution to devices in response to new input prompts being classified as similar to the first input prompt.

6. The method of claim 1, wherein sending either (i) one or more of the pre-generated digital components stored in the data structure or (ii) one or more new digital components generated by the trained machine learning model using the first input prompt comprises:
determining that the similarity metric for the one or more pre-generated digital components satisfies a similarity threshold;
in response to determining that the similarity metric for the one or more pre-generated digital components satisfies the similarity threshold, determining, based on a function, whether to send the one or more pre-generated digital components or to generate the one or more new digital components using customization information for a sender of the first input prompt;
whenever a determination is made to send the one or more pre-generated digital components, sending the one or more pre-generated digital components to the device; and
whenever a determination is made to generate the one or more new digital components using customization information for a sender of the first input prompt:
generating an updated prompt based on the first input prompt and the customization information for the sender of the first input prompt;
generating the one or more new digital components by providing the updated prompt to the one or more trained machine learning models; and
sending the one or more new digital components to the device.

7. The method of claim 1, wherein the data structure comprises a cache of the artificial intelligence system.

8. The method of claim 6, further comprising periodically updating the cache, the updating comprising:
determining, for each pre-generated digital component stored in the data structure, a duration of time since a last input prompt for which the similarity metric for the stored embedding used to generate the pre-generated digital component satisfies a similarity threshold was received; and
removing each pre-generated digital component for which the duration of time exceeds a duration threshold.

9. The method of claim 1, further comprising pre-populating the data structure with one or more digital components generated using human-created prompts that were not previously received from devices of senders.

10. The method of claim 1, further comprising pre-populating the data structure with one or more digital components generated using prompts generated by a language model.

11. The method of claim 1, further comprising:
generating, for a digital component provider, a new prompt based on information obtained from one or more resources of the content provider;
generating one or more new digital components using the new prompt; and
sending, as recommended digital components, the one or more new digital components to the content provider.

12. A system comprising:
one or more processors; and
one or more storage devices storing instructions that, when executed by the one or more processors, cause the one or more processors to perform operations comprising:
maintaining, by an artificial intelligence system, a data structure that stores a set of pre-generated digital components and, for each pre-generated digital component, a stored embedding the represents a prompt used to generate the pre-generated digital component;
receiving, by the artificial intelligence system from a device, a first input prompt for generating one or more first target digital components using one or more trained machine learning models, the first input prompt comprising a multi-word phrase describing characteristics of the first target digital component to be generated using the first input prompt;
generating, by the artificial intelligence system, a first input embedding that represents the multi-word text of the input prompt;
determining, by the artificial intelligence system and for each pre-generated digital component, a similarity metric that represents a measure of similarity between the stored embedding used to generate the pre-generated digital component and the first input embedding; and
sending, by the artificial intelligence system and to the device based on each similarity metric, either (i) one or more of the pre-generated digital components stored in the data structure or (ii) one or more new digital components pre-generated by the trained machine learning model using the first input prompt.

13. (canceled)

14. (canceled)

15. The system of claim 12, wherein sending either (i) one or more of the pre-generated digital components stored in the data structure or (ii) one or more new digital components generated by the trained machine learning model using the first input prompt comprises:
determining that the similarity metric for the one or more pre-generated digital components satisfies a similarity threshold; and
sending the one or more pre-generated digital components to the device in response to determining that the similarity metric for the one or more pre-generated digital components satisfies a similarity threshold.

16. The system of claim 12, wherein sending either (i) one or more of the pre-generated digital components stored in the data structure or (ii) one or more new digital components generated by the trained machine learning model using the first input prompt comprises:
determining that the similarity metric for each of a plurality of the pre-generated digital components satisfies a similarity threshold; and
in response to determining that the similarity metric for each of the plurality of the pre-generated digital components satisfies the similarity threshold:
selecting, from among the plurality of pre-generated digital components, the one or more pre-generated digital components based on the similarity metric for each of the plurality of pre-generated digital components; and
sending the one or more pre-generated digital components to the device.

17. The system of claim 12, wherein sending either (i) one or more of the pre-generated digital components stored in the data structure or (ii) one or more new digital components generated by the trained machine learning model using the first input prompt comprises:
determining that the similarity metric for each pre-generated digital components stored in the data structure fails to satisfy a similarity threshold; and
in response to determining that the similarity metric for each pre-generated digital component stored in the data structure fails to satisfy the similarity threshold:
generating the one or more new digital components by providing the first input prompt to the one or more trained machine learning models; and
sending the one or more new digital components to the device.

18. The system of claim 17, wherein the instructions cause the one or more processors to perform operations further comprising adding the one or more new digital components and the first input prompt to the data structure for distribution to devices in response to new input prompts being classified as similar to the first input prompt.

19. The system of claim 12, wherein sending either (i) one or more of the pre-generated digital components stored in the data structure or (ii) one or more new digital components generated by the trained machine learning model using the first input prompt comprises:
determining that the similarity metric for the one or more pre-generated digital components satisfies a similarity threshold;
in response to determining that the similarity metric for the one or more pre-generated digital components satisfies the similarity threshold, determining, based on a function, whether to send the one or more pre-generated digital components or to generate the one or more new digital components using customization information for a sender of the first input prompt;
whenever a determination is made to send the one or more pre-generated digital components, sending the one or more pre-generated digital components to the device; and
whenever a determination is made to generate the one or more new digital components using customization information for a sender of the first input prompt:
generating an updated prompt based on the first input prompt and the customization information for the sender of the first input prompt;
generating the one or more new digital components by providing the updated prompt to the one or more trained machine learning models; and
sending the one or more new digital components to the device.

20. A non-transitory computer readable storage medium storing instructions that, when executed by one or more processors, cause the one or more processors to perform operations comprising:
maintaining, by an artificial intelligence system, a data structure that stores a set of pre-generated digital components and, for each pre-generated digital component, a stored embedding the represents a prompt used to generate the pre-generated digital component;
receiving, by the artificial intelligence system from a device, a first input prompt for generating one or more first target digital components using one or more trained machine learning models, the first input prompt comprising a multi-word phrase describing characteristics of the first target digital component to be generated using the first input prompt;
generating, by the artificial intelligence system, a first input embedding that represents the multi-word text of the input prompt;
determining, by the artificial intelligence system and for each pre-generated digital component, a similarity metric that represents a measure of similarity between the stored embedding used to generate the pre-generated digital component and the first input embedding; and
sending, by the artificial intelligence system and to the device based on each similarity metric, either (i) one or more of the pre-generated digital components stored in the data structure or (ii) one or more new digital components pre-generated by the trained machine learning model using the first input prompt.

21. The non-transitory computer readable storage medium of claim 20, wherein sending either (i) one or more of the pre-generated digital components stored in the data structure or (ii) one or more new digital components generated by the trained machine learning model using the first input prompt comprises:
determining that the similarity metric for each of a plurality of the pre-generated digital components satisfies a similarity threshold; and
in response to determining that the similarity metric for each of the plurality of the pre-generated digital components satisfies the similarity threshold:
selecting, from among the plurality of pre-generated digital components, the one or more pre-generated digital components based on the similarity metric for each of the plurality of pre-generated digital components; and
sending the one or more pre-generated digital components to the device.

22. The non-transitory computer readable storage medium of claim 20, wherein sending either (i) one or more of the pre-generated digital components stored in the data structure or (ii) one or more new digital components generated by the trained machine learning model using the first input prompt comprises:
determining that the similarity metric for each pre-generated digital components stored in the data structure fails to satisfy a similarity threshold; and
in response to determining that the similarity metric for each pre-generated digital component stored in the data structure fails to satisfy the similarity threshold:
generating the one or more new digital components by providing the first input prompt to the one or more trained machine learning models; and
sending the one or more new digital components to the device.
